(19) United States
(12) Patent Application Publication
(10) Pub. No.: US 2004/0069797 A1
(43) Pub. Date: Apr. 15, 2004

(54) Gas extraction Apparatus

(76) Inventors: Andrew Tien, Chino Hills, CA (US); Jarvis D. Tien, Chino Hills, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/262,468

(22) Filed: Sep. 30, 2002

(51) Int. Cl. B67D 5/00

(52) U.S. Cl. 222/3

(57) ABSTRACT

A gas extraction apparatus is used within a pressure vessel for extracting gas from the vessel while leaving liquid. A neck fitting is adapted for threaded engagement within a neck of a pressure bottle. An expansion chamber is threaded into the neck fitting. The expansion chamber extends distally and axially into the pressure bottle. The expansion chamber is threaded into the adapter fitting and a suction tube terminates with a circular flange engaged for rotation within the adapter fitting. A compression spring is fitted between the obverse side of the circular flange of the suction tube and a terminal distal surface of the expansion chamber. A seal is positioned between the reverse side of the circular flange and an internal annular surface of the adapter fitting. A further seal is positioned between the proximal end of the tube body and an annular seal retaining groove within the adapter fitting. An eccentric weight, and/or a floatation means, is fixed to the suction tube and is positioned for urging rotation of the suction tube to maintain a distal terminal end of the suction tube at an elevated position for suction of gas rather than the liquid within the pressure bottle.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

1. Field of the Invention

This invention relates generally to the extraction of gas from compressed gas bottles wherein a mixture of gas and liquid is contained within the bottle and it is desired to remove the gas component only without any liquid, where the bottle is expected to be moved over a range of orientations about its horizontal axis.

2. Description of Related Art

The following art defines the present state of this field:

Jackson, U.S. Pat. No. 2,740,563 teaches a fitting adapted for receiving liquid from the bottom of a tank or pressure vessel.

Gattineri, U.S. Pat. No. D426,768 teaches a design for a foam dispenser.

Abplanalp, U.S. Pat. No. 2,932,433 teaches a dispenser with flexible suction tube and a chamber built into the tube capable of holding one dispensing of product.

Prussin et al, U.S. Pat. No. 3,211,349 teaches an aerosol dispenser with a flexible suction tube capable of maintaining suction no-matter the orientation of the dispenser.

Kieffer et al, U.S. Pat. No. 5,655,714 teaches a spray gun with a pivotal siphon tube manually positionable.

Wagner, U.S. Pat. No. 580,437 teaches a container with manually rotational suction tube.

Eagle, U.S. Pat. No. 2,219,178 teaches a rotational suction tube with seals.

Gallien et al, U.S. Pat. No. 5,522,548 teaches a swivelly mounted, ball in socket type movable suction tube.

Evans et al, U.S. Pat. No. 2,740,563 teaches an aerosol spray dispenser with swinging suction tube mounted in a concave bottom so that the tube is able to suction to very low liquid levels.

Cone, U.S. Pat. No. 2,569,975 teaches a fire extinguisher with direction adjustable suction tube.

Kerley, Jr., U.S. Pat. No. 2,956,713 teaches a dispenser with manually positionable suction tube.

Barriac, U.S. Pat. No. 2,740,563 teaches a sprayer with floatation at the end of the suction tube to assure liquid pickup no-matter the orientation of the device.

Freeland et al, U.S. Pat. No. 5,105,996 teaches a propane cylinder with a suction tube brace to prevent the tube from fatigue cracking.

The prior art teaches tube braces within pressure bottles, liquid pickup and gas venting, liquid metering, crooked suction tubes, swinging suction tubes, aerosol dispensers, suction tube mounted chambers, and liquid receiving fittings, but does not teach a gas suction apparatus with rotating tube to maintain gas drawing only. The present invention fulfills these needs and provides further related advantages as described in the following summary.

### SUMMARY OF THE INVENTION

The present invention teaches certain benefits in construction and use which give rise to the objectives described below.

In certain applications, such as in paintball firearms, a pressure vessel or tank is used to provide gas pressure for expelling a projectile. In such applications the pressure vessel is filled with a liquid such as carbon dioxide under pressure and results in a gas-over-liquid combination where it is desired to draw from the gas portion and not from the liquid portion. The present invention is a gas extraction apparatus inserted into the pressure vessel and used for extracting the gas component from the bottle while leaving the liquid component although the pressure vessel is rotated during use. A neck fitting is threaded engaged within a neck of a pressure bottle. An expansion chamber is threaded into the neck fitting. The expansion chamber extends axially into the pressure vessel or bottle. The expansion chamber is threaded into the adapter fitting and a suction tube terminates with a circular flange engaged for rotation within the adapter fitting. A compression spring is fitted between the circular flange of the suction tube and a terminal distal surface of the expansion chamber. A seal is positioned between the other side of the circular flange and an internal annular surface of the adapter fitting. A further seal is positioned between the proximal end of the tube body and an annular seal retaining groove within the adapter fitting. These seals prevent liquid from entering the expansion chamber. An eccentric weight is fixed to the suction tube and urges rotation of the suction tube to maintain a distal terminal end of the suction tube at an elevated position for suction of gas rather than the liquid within the pressure bottle. When liquid is drawn into the expansion chamber through the suction tube it expands into a gas and is expelled through the neck fitting without impeding the flow of gas.

A primary objective of the present invention is to provide an apparatus and method of use of such apparatus that provides advantages not taught by the prior art.

Another objective is to provide such an invention capable of maintaining suction of only the gas component of a gas-liquid combination within a pressure bottle although the bottle is expected to rotate about its major axis during use.

A further objective is to provide such an invention capable of evaporating small amounts of liquid that might be extracted from the liquid portion of the pressure bottle's contents.

A still further objective is to provide such an invention capable of being used with standard gas pressure bottles.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawing illustrates the present invention. In such drawings:

FIG. 1 is a sectional view of the preferred embodiment of the invention with a gas expansion chamber;

FIG. 2 s a partial, enlarged, view of FIG. 1 taken along line 2-2 shown in FIG. 1; and

FIG. 3 is similar to FIG. 1 showing an alternate embodiment of the invention without the expansion chamber.

### DETAILED DESCRIPTION OF THE INVENTION

The above described drawing figures illustrate the invention in at least one of its preferred embodiments, which is further defined in detail in the following description.

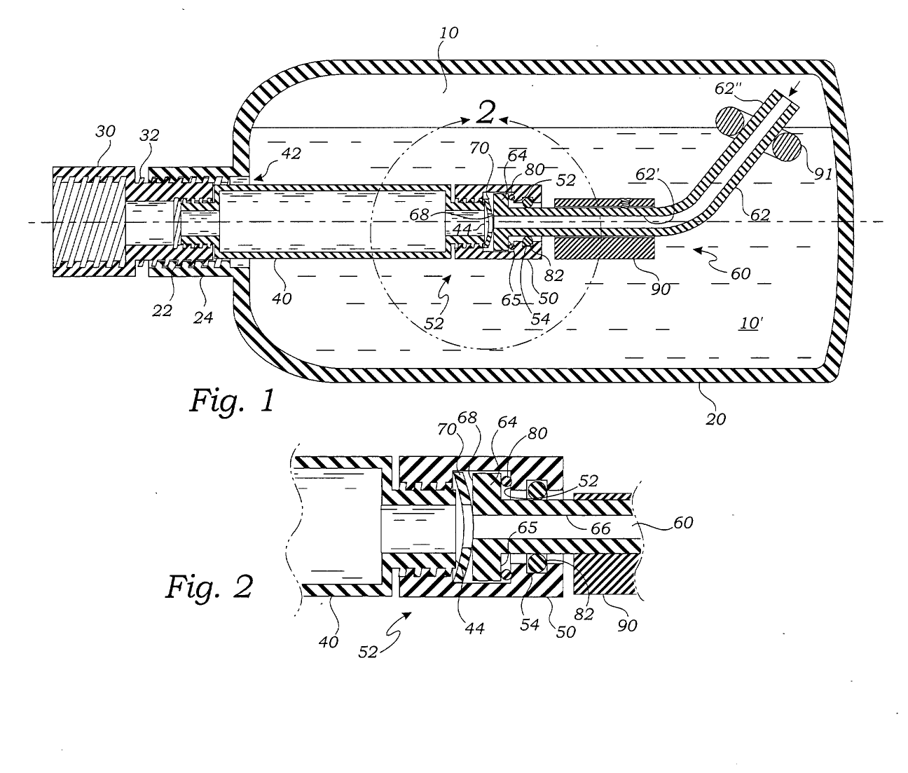

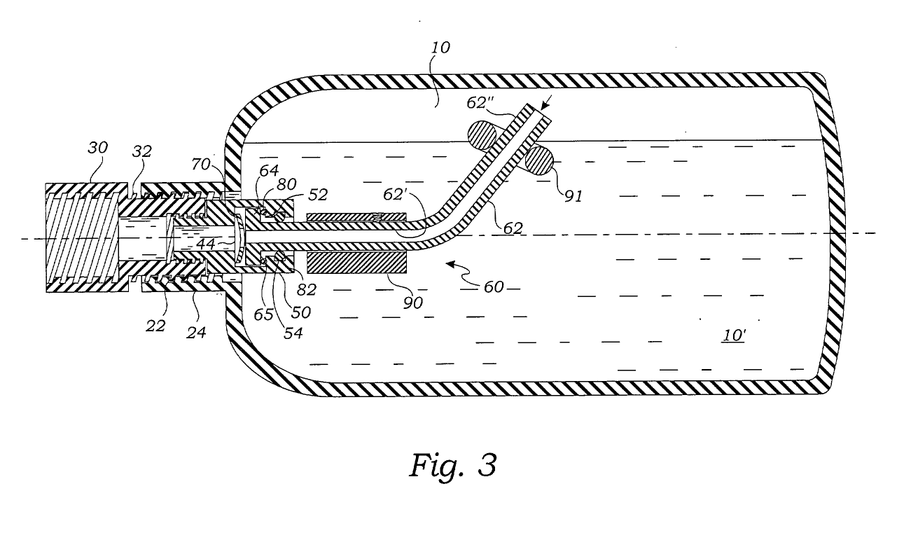

The present invention, as shown in FIG. 1, is a gas extraction apparatus for use with a compressed gas 10 contained over liquid 10′ within a pressure bottle or vessel 20. A bottle neck fitting 30 is adapted with an external machine thread 32 for threaded engagement with a corresponding internal machine thread 22 in the neck 24 of the pressure bottle 20. In the embodiment shown in FIG. 1, an expansion chamber 40 is threaded in engagement, at a proximal end 42, with the bottle neck fitting 30. In an alternate embodiment shown in FIG. 3, the expansion chamber is not used, so that the adapter fitting 40 is adapted with an external thread at its distal end for engagement directly with bottle neck fitting 30 as shown in FIG. 3. The expansion chamber 40, when used, extends distally and axially into the pressure bottle 20. The adapter fitting 50 is threaded in engagement, at a proximal end 52, with the expansion chamber 40 as shown in FIG. 1. A suction tube 60 provides a hollow tube body 62 terminating with a right circular flange 64 at a proximal end 66, the flange 64 and proximal end 66 of the tube body 62 engaged within the adapter fitting 50 and separated by a compression spring 70, such as the wave washer shown, between a proximal side 68 of the circular flange 64 and a terminal distal surface 44 of the expansion chamber 40 or the bottle neck fitting 30. A seal 80, preferably a lubricated rubber o-ring, is positioned between a distal side 65 of the circular flange 64 and an internal annular surface 52 of the adapter fitting 50. A bearing set 82, is positioned between the proximal end 66 of the tube body 62 and an annular seal retaining groove 54 within the adapter fitting 50. In this manner, the liquid 10′ is prevented from moving past the seal 80 and into the expansion chamber 40 while still allowing the 'suction tube 60 to rotate. The seal 80 is enabled by compression forces and by lubricant for sealing against relatively slow and limited rotational motion of the tube 60. In one embodiment, an eccentric weight 90 is fixed to the suction tube body 62 proximate the adapter fitting 50 on an axial portion 62′ of the tube body 62, the eccentric weight 90 positioned for urging rotation of the suction tube 60 within the adapter fitting 50, to maintain a distal terminal portion 62″ of the suction tube 60 at an elevated position within the pressure bottle 20. The distal terminal portion 62″ is formed at an obtuse angle with the axial portion 60′ so as to allow the tube 60 to be inserted through the neck 24 of the pressure bottle 20. As shown in FIG. 1, in operation, the suction tube 60 is always positioned for drawing the gas portion 10 within the pressure bottle 20 as long as the pressure bottle 20 is laying with its central axis in the horizontal orientation. When the bottle rotates about its central axis, the eccentric weight 90 and-or a means for floatation 91, such as a light weight material, as for instance, cork, is attached to the suction tube 60, as is known in the art, causing the suction tube 60 to rotate to a new position with its terminal end still positioned within the gas component 10. When liquid 10′ is drawn into the suction tube 60 it is undesirable. Such liquid 10′ moves into the expansion chamber 40 where it is able to expand into the gas phase while still allowing the gas 10 to escape through the neck fitting 30. While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A gas extraction apparatus for use with a compressed gas contained within a pressure vessel, the apparatus comprising: a bottle neck fitting adapted for threaded engagement within a neck of a horizontally oriented pressure vessel; an adapter fitting threaded in engagement with the bottle neck fitting; a suction tube terminating with a circular flange at a proximal end thereof, the circular flange and proximal end of the suction tube engaged within the adapter fitting; a compression spring fitted between the circular flange and a terminal distal surface of the bottle neck fitting; a seal positioned between the circular flange and an internal annular surface of the adapter fitting, a bearing set positioned between the proximal end of the suction tube and an annular bearing retaining groove within the adapter fitting, and an eccentric weight fixed to an axial portion of the suction tube proximate the adapter fitting, the eccentric weight positioned for urging rotation of the suction tube and circular flange, when the pressure vessel rotates, to maintain a distal terminal end of the suction tube at an elevated position within the gas phase of a gas-over-liquid contents within the pressure vessel.

2. The apparatus of claim 1 further comprising an expansion chamber fitted between the bottle neck fitting and the adapter fitting, the expansion chamber extending distally and axially into the pressure vessel

3. The apparatus of claim 1 wherein the seal is an o-ring.

4. The apparatus of claim 1 wherein the seal enables sliding, low friction sealing.

5. The apparatus of claim 1 wherein the compression spring is a wave washer.

6. A gas extraction apparatus for use with a compressed gas contained within a pressure vessel, the apparatus comprising: a bottle neck fitting adapted for threaded engagement within a neck of a horizontally oriented pressure vessel; an adapter fitting threaded in engagement with the bottle neck fitting; a suction tube terminating with a circular flange at a proximal end thereof, the circular flange and proximal end of the suction tube engaged within the adapter fitting; a compression spring fitted between the circular flange and a terminal distal surface of the bottle neck fitting; a seal positioned between the circular flange and an internal annular surface of the adapter fitting, a bearing set positioned between the proximal end of the suction tube and an annular bearing retaining groove within the adapter fitting, and a means for floatation fixed to the suction tube for urging rotation of the suction tube and circular flange, when the pressure vessel rotates, to maintain a distal terminal end of the suction tube at an elevated position within the gas phase of a gas-over-liquid contents within the pressure vessel.

7. The apparatus of claim 6 further comprising an expansion chamber fitted between the bottle neck fitting and the adapter fitting, the expansion chamber extending distally and axially into the pressure vessel

8. The apparatus of claim 6 wherein the seal is an o-ring.

9. The apparatus of claim 6 wherein the seal enables sliding, low friction sealing.

10. The apparatus of claim 6 wherein the compression spring is a wave washer.

11. A gas extraction apparatus for use with a compressed gas contained within a pressure vessel, the apparatus comprising: a bottle neck fitting adapted for threaded engagement within a neck of a horizontally oriented pressure vessel; an adapter fitting threaded in engagement with the bottle neck fitting; a suction tube terminating with a circular flange at a proximal end thereof, the circular flange and proximal end of the suction tube engaged within the adapter fitting; a compression spring fitted between the circular flange and a terminal distal surface of the bottle neck fitting; a seal positioned between the circular flange and an internal annular surface of the adapter fitting, a bearing set positioned between the proximal end of the suction tube and an annular bearing retaining groove within the adapter fitting; a means for floatation fixed to the suction tube; and an eccentric weight fixed to an axial portion of the suction tube proximate the adapter fitting, the eccentric weight and the floatation means each positioned for urging rotation of the suction tube and circular flange, when the pressure vessel rotates, to maintain a distal terminal end of the suction tube at an elevated position within the gas phase of a gas-over-liquid contents within the pressure vessel.

12. The apparatus of claim 11 further comprising an expansion chamber fitted between the bottle neck fitting and the adapter fitting, the expansion chamber extending distally and axially into the pressure vessel

13. The apparatus of claim 11 wherein the seal is an o-ring.

14. The apparatus of claim 11 wherein the seal enables sliding, low friction sealing.

15. The apparatus of claim 11 wherein the compression spring is a wave washer.
